(19) United States
(12) Patent Application Publication
(10) Pub. No.: US 2004/0057464 A1
(43) Pub. Date: Mar. 25, 2004

(54) Generic Transport layer

(76) Inventor: Michael Sanders, The Sea Ranch, CA (US)

Correspondence Address: Fay Kaplun & Marcin, LLP, Suite 702, 150 Broadway, New York, NY, 10038, US

(21) Appl. No.: 10/252,989

(22) Filed: Sep. 23, 2002

(51) Int. Cl. H04J 3/22

(52) U.S. Cl. 370/469

(57) ABSTRACT

A generic transport layer interface is described, to connect protocol independent communications applications with specific transport layer protocols. An abstraction layer core is provided, where data received from the communications applications is used to generate data that can be sent to the specific transport layer protocols. A protocol independent transport interface connects the abstraction core to the communications applications, and a transport specific interface connects the abstraction core to the transport layer protocols. Transport layer protocols such as UDP, TCP and SCTP are supported.

### BACKGROUND INFORMATION

The public switched telephone network (“PSTN”) encompasses the world's collection of interconnected voice-oriented public telephone networks. The PSTN is an aggregation of circuit switching telephone networks which route phone calls between consumers. Today, the PSTN is almost entirely digital technology, but some analog remnants remain (e.g., the final link from a central office to the user). The transmission and routing of calls via the PSTN is governed by a set of standards so that various providers of telephone service may easily route calls between their customers. Thus, a first consumer having telephone service A is able to call a second consumer having telephone service B, and the routing of such a call may go through networks owned by various other telephone services C-E. The result being the appearance of a seamless transmission between the first and second consumers.

As an alternative to using standard telephones on the PSTN, consumers may also use their personal computers (“PCs”) to make phone calls to other PC users. The transmission of a call via a PC is generally referred to as Voice over Internet Protocol (“VolP”) technology. VolP is a set of facilities for managing the delivery of voice information using the Internet Protocol. These PC to PC phone calls are transmitted via the Internet. However, in some instances, a consumer on a standard telephone desires to call a consumer using a PC phone, or vice versa. Thus, standards have been developed to effectively route these types of phone calls.

A variety of protocols are used to handle telephone calls made to and from PC's, such as the MEGACO standard by the Internet Engineering Task Force (IETF), the Media Gateway Control Protocol (MGCP) and the Session Initiation Protocol (SIP). These protocols seek to bridge the gap between circuit based public switched networks and Internet Protocol (IP) based networks. Each of the protocols uses different conventions and has different sets of function calls and variables, which generally require an interface tailor made for the specific protocol to communicate with the transport layer. On the other hand, many different protocols also exist at the transport layer level, where the calls are routed to the Internet. The User Datagram Protocol (UDP), Stream Control Transmission Protocol (SCTP) and the Transmission Control Protocol (TCP) are three such protocols. As before, access to each protocol requires an interface that is specific to that protocol. Further, different systems may utilize different application programming interfaces (API's) for access to these protocols. Finally, the protocol implementation may, in some cases, be supplied by the operating system vendor, or in other cases by a third-party vendor.

### SUMMARY OF THE INVENTION

In one exemplary embodiment, the present invention is an abstraction layer to connect a communications applications to a computer network, which includes a generic transport layer core, having an abstraction element to generate interfaces to transport layer protocols, a transport specific interface relating the generic transport layer core to transport layer protocol applications, and a protocol independent transport interface relating the generic transport layer core to the communications application.

### BRIEF DESCRIPTION OF THE DRAWINGS

FIG. 1 is a diagram showing an exemplary telephone to internet connection according to embodiments of the present invention;

FIG. 2 is a diagram showing an embodiment of a transport layer according to the present invention;

FIG. 3 is a diagram showing an exemplary exchange of primitives between client and services;

FIG. 4 is a diagram showing the interfaces of a transport layer according to embodiments of the present invention;

FIG. 5 is a diagram showing an exchange of primitives mediated by a delivery agent;

FIG. 6 is a flowchart showing exemplary steps of an exchange of primitives between client and service; and

FIG. 7 is a diagram showing an embodiment of a service access point according to the invention.

### DETAILED DESCRIPTION

The present invention may be further understood with reference to the following description of preferred exemplary embodiments and the related appended drawings, wherein like elements are provided with the same reference numerals. The exemplary embodiments described herein refer to voice communications (e.g., phone calls). However, those of skill in the art will understand that the present invention may be equally applied to systems, networks and/or hardware used for communication of data or other information. Those of skill in the art also understand the basic concepts of the transmission of voice and/or data information across network devices. Those who desire a more detailed discussion of network data transfer may consult a reference such as, Perlman, Radia “Interconnections Second Edition—Bridges, Routers, Switches, and Internetworking Protocols,” Addison Wesley, 2000.

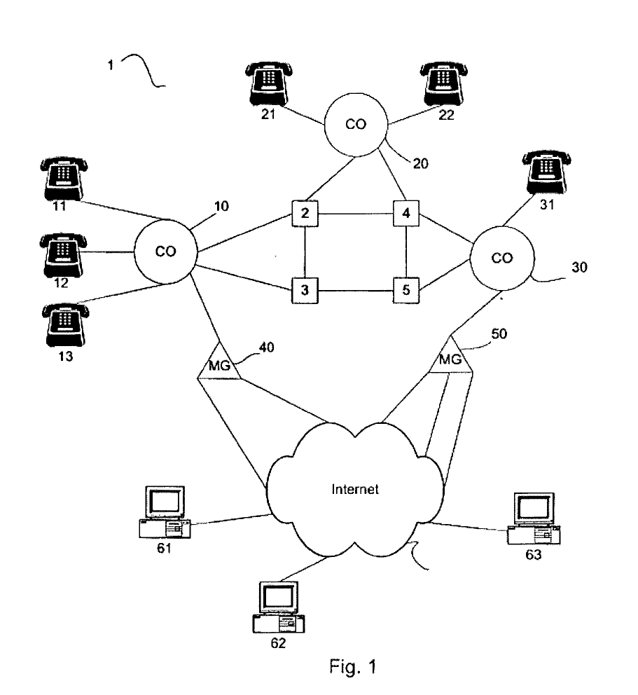

FIG. 1 shows an exemplary network arrangement 1 for the connection of voice communications. The network arrangement 1 includes three central offices (“CO”) 10-30 which are locations where telephone companies terminate customer lines and locate switching equipment to interconnect those lines with other networks. In this example, the customer lines 11-13 terminate at the CO 10, the customer lines 21-22 terminate at the CO 20 and the customer line 31 terminates at the CO 30. The customer lines may be any type of lines, for example, plain old telephone service (“POTS”) lines, integrated services digital network (“ISDN”) lines, frame relay (“FR”) lines, etc. In this example, each of the customer lines (e.g., customer line 11) may be considered a POTS line attached to a standard telephone at the customer location.

Between the COs 10-30, there may be a series of switching stations 2-5. These switching stations 2-5 direct the calls along a route from a transmitting CO to a receiving CO. For example, a user on the customer line 11 may attempt to call a user at the customer line 31. The call will be transmitted from the customer line 11 to the CO 10, which will then route the call into the system to arrive at the CO 30. When the call is in the system, it may take a variety of routes between the CO 10 and the CO 30 based on various parameters, e.g., system traffic, shortest route, unavailable switches, etc. In this example, the call may be routed from the CO 10 to the switching station 2, through to the switching station 4 and then to the CO 30 which connects the call to the customer line 31. The portion of the network arrangement 1 described above may be considered the PSTN portion of exemplary network arrangement 1.

In addition, there may be a VoIP portion of network arrangement 1. In this example, personal computers (“PC's”) 61-63 or embedded computing platforms, e.g. VoIP phones, PDA's, automobile communicators, etc. are equipped with hardware and software allowing users to make voice phone calls. The PCs 61-63 have connections to the Internet 60 for the transmission of the voice data for the phone calls made by the users. If a PC user makes a voice call to another PC user (e.g., user of PC 61 calls user of PC 62), the call may be routed from the PC 61 through the Internet 60 to the PC 62. However, for calls from the PSTN portion of the network arrangement 1 to the VoIP portion, media gateways (“MG”) 40-50 act as a router for such calls. Thus, if the user of PC 61 calls the user of customer line 31, the call may be routed from the PC 61 through the Internet 60 to the MG 50 and through to the CO 30 which connects the call to the customer line 31. Those of skill in the art will understand that the previously described components are only exemplary and that there may be other components used to route calls, for example, the VoIP portion of the network may contain a media gateway controller.

As seen from the above described examples, the phone calls are routed through the exemplary network arrangement 1 by a variety of hardware devices (e.g., COs, switching stations, MGs, etc.). Standards groups have been set up to promulgate standards for the protocols to route these phone calls through the various telephone systems. For example, Signaling System 7 (“SS7”) is a telecommunications protocol defined by the International Telecommunications Union (“ITU”). For a more detailed discussion of SS7 see the following standard publication, “ANSI, T1.110-1992, Signaling System 7 (SS7) General Information, 1992” and the sequence of standards, ANSI, T1.111-114, related to SS7. In general, the SS7 protocol is implemented on the PSTN portion equipment (e.g., CO 10-30, switching stations 2-5) and may be used for a variety of features related to phone calls, for example, basic call setup, management, tear down, local number portability, toll-free and toll wireline services, call forwarding, three-way calling, etc.

Another example of a protocol standard for the VoIP portion of network arrangement 1 is the MEGACO standard by the Internet Engineering Task Force (“IETF”). For a more detailed discussion of the MEGACO standard see the following publication, “IETF, RFC 3015, Megaco Protocol Version 1.0.” MEGACO defines the protocols used between elements of a physically decomposed multimedia gateway consisting of a MG (e.g., MGs 40-50) and a Media Gateway Controller. Those of skill in the art will understand that the above described protocols are only exemplary and that additional implemented protocols exist, while new protocols may be implemented in the future. The present invention is equally applicable to any of these systems implementing protocols.

Thus, each of the described components in network arrangement 1 may implement a variety of protocols to route calls to the desired location. The described components may include one or more processors or other computing devices to provide the desired functionality (e.g., routing of the phone calls, etc.). These components may contain software elements to instruct the processor (or other computing device) to perform the desired functions and implement the various protocols. The present invention may be implemented on any of the above described components or any other processor based components used in the transfer of information through a network.

The various protocols implemented by the components of the network arrangement 1 use different function calls, conventions and variables that may not be compatible with one another. In particular, applications such as MEGACO may have to exchange data with a variety of transport layer protocols that are associated with a computer network. A generic interface is necessary that is designed specifically to facilitate interconnection between software elements using different operating conventions. Exemplary embodiments of the present invention include a generic transport layer (XTL) that provides a common application programming interface (API) for applications to access the various transport layers.

More specifically, applications that use XTL don't have to be optimized to interact with any one specific transport layer protocol, but instead can be generalized, since the generic transport layer performs the task of converting the general instructions of the application to the specific instructions accepted by the transport layer protocols. In this context, “instructions” is meant to include constant, variables, function calls and arguments, among others. XTL also insulates applications from the operating system-specific aspects of the transport API, including whether the executing thread blocks while waiting for transport API services (commonly referred to as synchronous execution). XTL converts all transport protocol actions into asynchronous events. The system according to embodiments of the present invention hides from the user operating system-specific issues, such as the way a module gets an execution thread from platforms that are based on Microsoft Windows®, Unix®, VxWorks® or other operating systems.

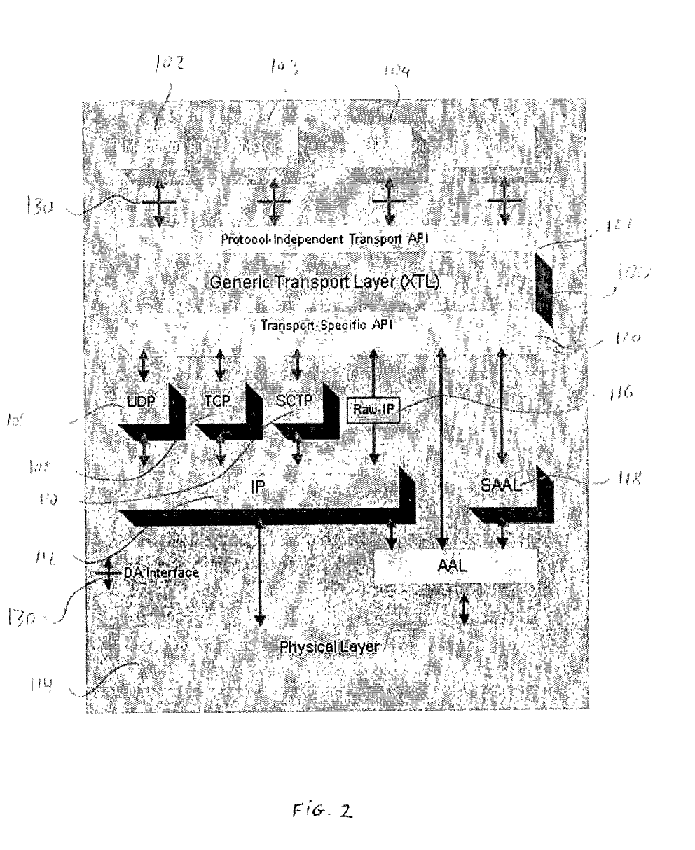

FIG. 2 schematically shows the positioning of the XTL within a transport layer. The generic transport layer 100, alternatively referred to as XTL, is conceptually located within the transport layer connecting the VoIP applications to the Internet. Several VoIP applications may be used in this context, shown by reference numerals 102-104, within the application, presentation and session layers of the data transfer model. These applications include the various standards for connecting a standard telephone call to an Internet call and vice versa, and include MEGACO, MGCP, SIP and other existing or future telephony or communications applications. On the network side of XTL 100 may be found the specific protocols that handle the host to host transfer of data. These protocols may include UDP 106, TCP 108 and SCTP 110. In addition, a Raw-IP protocol 116, described in more detail below, may also be accessed through XTL 100.

As shown in FIG. 2, an exemplary embodiment of the generic transport layer 100 includes two interfaces. A Protocol-Independent Transport API 122 presents an interface to applications in the application layer which is the same regardless of which Internet protocol is actually used to transfer data between hosts. Transport independent data and inputs may be exchanged through the Protocol-independent Transport API 122. Any of the gateway applications 102-104 or any other suitable application can access XTL 100 via the Protocol-Independent Transport API 122, while having to know few details of the Internet protocol being used. This interface is the user interface to XTL 100. In an exemplary embodiment according to the invention, Protocol-Independent Transport API 122 between XTL 100 and applications 102,103 and 104 may be fully integrated with those applications. Accordingly, the user needs to take no additional actions to set up the interface to work with MEGACO 102, MGCP 103 and SIP 104. However, an additional direct interface to the IP layer 112 is also provided, as described below, to allow developers to implement new protocols over IP as needed.

Another API of XTL 100 is the Transport Specific API 120, which provides the interface to the specific transport layer such as TCP 108, UDP 106, SCTP 110. Protocol specific data and inputs may be exchanged through Transport Specific API 120. To take into account the need for extensibility, scalability and portability, support is also provided for Asynchronous Transfer mode (ATM) communications and for a Raw-IP interface 116. Raw-IP interface 116 provides a direct connection between XTL 100 and the IP layer 112, bypassing the more typical Internet protocols 106-110. By using the Raw-IP interface 116, extensions to XTL 100 may be developed and added to implement new protocols over the IP layer 112. In one exemplary embodiment, XTL 100 provides a Transport-Specific API 120 for both Microsoft Windows NT® and Sun Solaris® versions of UDP, TCP and SCTP protocols 106-110. When one of these listed systems is used, transport specific API 120 according to this exemplary embodiment may be fully integrated with the transport protocols. No additional coding or development is required to connect XTL 100 to those systems.

The generic transport layer according to embodiments of the present invention includes two basic components. The generic transport layer (XTL) 100 and its interfaces, as described above, and the delivery agents (DA) 130. The first component, XTL 100, is the transport layer abstraction that provides a protocol independent transport interface to uniformly support multiple underlying transport networks, such as IP and ATM. XTL 100 offers an interface that handles the protocols in a uniform and generic manner, which is extensible to future transport protocols. With XTL 100 the applications accessing the transport layer can be developed as generic applications, not limited to operating with a specific transport protocol. The application developers thus don't have to be proficient with the details of the transport protocols, and only are required to develop one version of the application that is compatible with the generic transport layer protocol.

A second component of the generic transport layer according to exemplary embodiments of the invention is the delivery agent 130. DA 130 forms the connection between different layers in the network connection model. Information is handled by the DA 130 in the form of “primitives”, which are used by the layers to bind with one another. DA 130 provides a portable mechanism that protocol modules use to exchange information with one another in the form of primitives. Internally, DA 130 may use either a function-call interface or a message-based interface to carry out its data exchange functions. However, the internal workings of DA 130 are transparent to the layers that are doing the binding. In the exemplary embodiment of FIG. 2, the DA 130 connects applications such as MGCP 103 and SIP 104 to the protocol independent transport API 122 of XTL 100. DA 130 may also support timer and signal delivery function with the layers of the network connection model.

Generic transport layer 100 maintains a client-service relationship with the software components to which it is connected. These software components may be, for example, applications 102-104 shown in FIG. 2. XTL 100 provides a documented set of services and corresponding interface primitives to carry out the client-service relationship. A component that desires to access the services of another component using XTL 100 must adhere to the interface requirements of that component. A “client” component wishing to use the services of another component must register with DA 130 to bind with the desired “service” component. The binding between client and service is referred to as a Service Access Point (SAP).

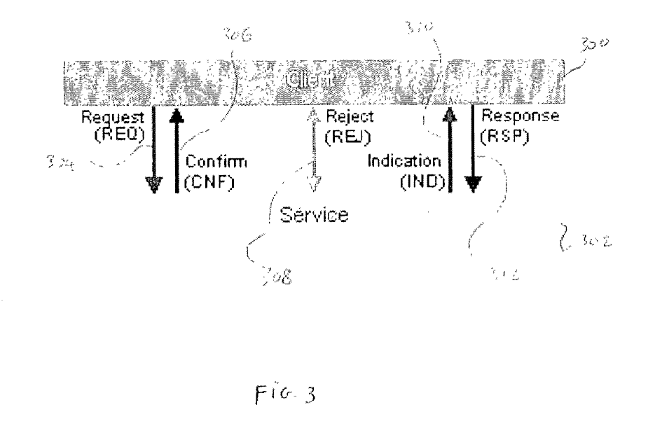

FIG. 3 shows a diagram of the exchange of primitives between the XTL service and its client. The process is initiated by the client 300, which sends a request (REQ) 304 to service 302 to initiate some service action. A confirmation (CNF) 306 is then sent from service 302 to client 300, to confirm reception and provide a reply to request 304. An indication (IND) 310 may be sent by the service 302 to client 300, to indicate some activity at the service layer. For example, indication 310 may notify the client 300 of a request from a remote user. Responses (RSP) 312 are made by the client 300 to service 302, and are only made in reply to a previous indication 310. In the exemplary embodiment according to the invention, not all the indications 310 and requests 304 are associated to corresponding responses 312 or confirmations 306. The requirement for a reply depends on the definition of the primitives being exchanged between client 300 and service 302. A reject (REJ) 308 may be sent by either client 300 or service 302 to indicate that a REQ 304 or IND 310 has not been accepted.

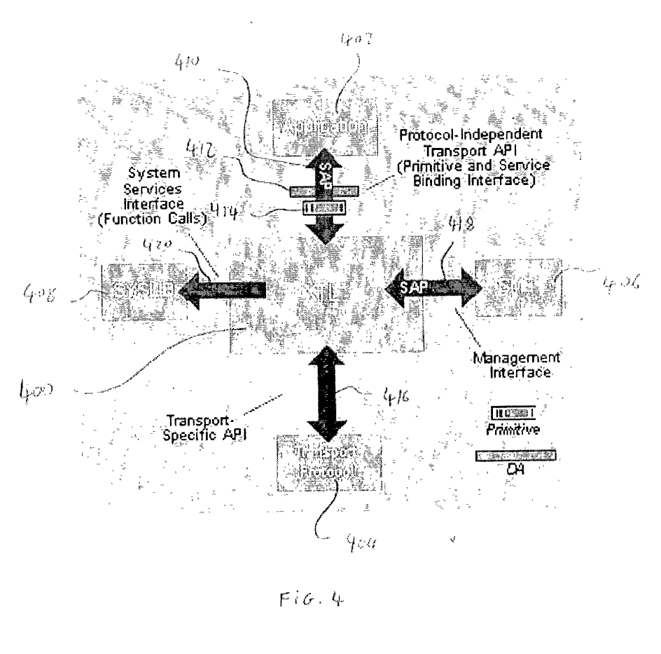

The basic structure of an exemplary embodiment of the generic transport layer according to the present invention is depicted in FIG. 4. XTL core module 400 is connected to the application layer and to the transport layer by various interfaces, and additionally may be connected to management and library utilities. Five principal interfaces are provided in this exemplary embodiment. The protocol independent transport API 410 consists of two separate interfaces: a Service Binding Interface for binding clients to XTL core 400, and a Primitive Exchange Interface for passing primitives between XTL core 400 and the client, such as application 402. Both of these interfaces that form the protocol independent transport API 410 are mediated by a delivery agent (DA) 412, and will be described in greater detail below. On the transport layer side, the XTL core 400 has a transport specific API 416 that connects it with a transport protocol 404. Several transport specific API's 416 are used to provide interfaces to each specific transport layer protocol. As described above, the transport protocol 404 may be one of a UDP, TCP, SCTP or other transport protocol.

A transport layer specific interface 416 connects XTL core 400 to an appropriate transport layer protocol 404, as shown in FIG. 4. The generic transport layer according to embodiments of the present invention is designed to support several different transport layers. One exemplary implementation, as shown in FIG. 2, supports UDP 106 over IP, TCP 108 over IP, SCTP 110 over IP and direct access over the IP layer, referred to as Raw IP 116. The information to generate interfaces specific to each of the listed transport layer protocols may be stored in specific files of XTL core 400. The transport mechanisms may utilize socket file descriptors (FD's), and XTL core 400 may maintain state variables used to take action when a FD indicates some event. For example, when a peer requests a connection to the client, XTL core 400 may accept the request and send a primitive, such as “TL_CONN_IND”, to the client. The client then validates the peer and either accepts or rejects it. To reject the peer, the client sends to XTL core 400 a specific disconnect primitive. To accept the peer, the client calls a function such as DaAddClient( ) to create a new SAP, as described above. The client then may send an appropriate response primitive using the new SAP.

In addition to the interfaces to the transport layer and the application layer, XTL core 400 also interfaces with a system library (SYSLIB) 408 and a system management entity (SME) 406. SYSLIB 408 is accessed by XTL core 400 through a system services interface 420, which provides access to operating system services. System services interface 420 allows access to the abstraction layer provided by SYSLIB 408 to handle buffers, timers and the like. For example, functions may be provided in SYSLIB 408 to allocate, copy and release buffers, and to start and stop timers that have been created by XTL core 400. SYSLIB 408 is used according to the present invention to isolate operating system dependencies from the operation of XTL core 400.

SME 406 is accessed through a management interface 418, which handles configuration, initialization and management services to XTL core 400. SME 406 separates the system dependent configurations and management functions from the application elements, and acts as a repository for objects handled by the application's stack. SME 406 perform initialization and coordination of the different modules. Configuration information is managed by management interface 418, and is useful when a client is bound to a service. Management functions can include, for example, initialization and startup functions accessed by XTL core 400. SME 406 provides client-service relationships, and may also provide direct “well-known” function call services to any component. One advantage of the XTL interface to SME 406, according to the present invention, is that any transport protocol-dependent details of the service are isolated to the SME 406 and to the application that configures the SME 406. This system allows the clients of XTL to avoid addressing these dependencies.

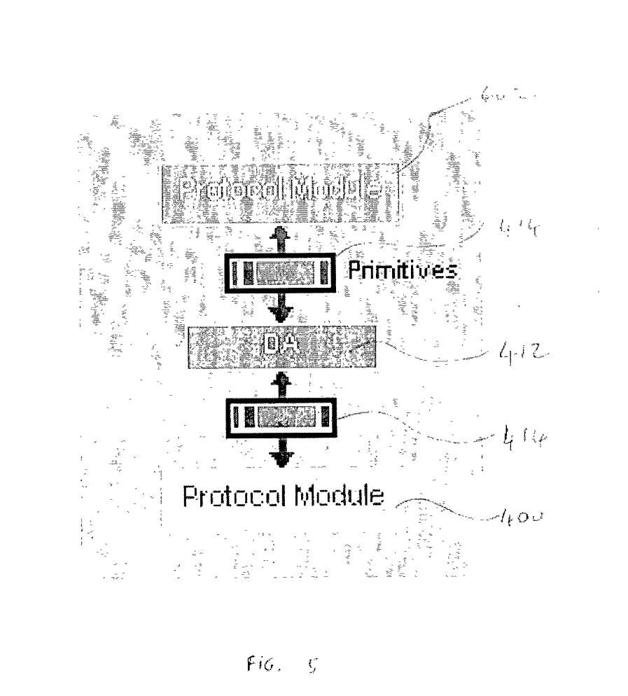

As indicated above, the protocol independent transport interface 410 comprises two sub-interfaces that are mediated by a delivery agent 412. These two interfaces, the primitive and service binding interfaces, use DA 412 to provide a common method of interface between protocol layers. There are two modes of operation that are used when modules use DA 412 to exchange primitives 414: as a service and as a client. A single module may offer a number of services, and may be a client of any number of other services. As shown schematically in FIG. 5, DA 412 provides a portable mechanism that client and service modules use to exchange information in the form of basic units of information, or primitives 414. In this example, the client may be a protocol module such as application 402, and the service may be another protocol module, such as XTL core 400. Thus, XTL can support many different clients, and clients of the XTL service may also be clients of other services. These clients may themselves offer services to other modules. However, it will be apparent to those of skill in the art that this characterization is purely exemplary, and the same DA mediated data transfer using primitives 414 may take place between any two modules.

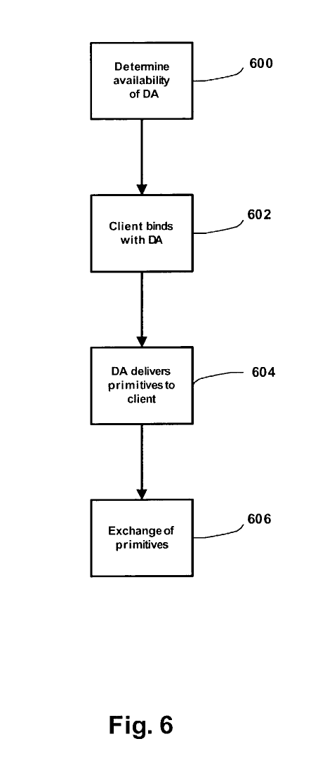

The first step in exchanging primitives between a service and a client is to create a service-client binding through the DA 412. The sequence of events that involve the service-client binding is described with reference to the flow chart of FIG. 6. A service module, for example XTL core 400, announces the availability of its services to DA 412 in step 600, for example by sending a call to a DA function DaAddService( ). The arguments of this function may include, for example, pointers to two callback functions. The NewClientFunc( ) is used by DA 412 to deliver new client requests, and the PrimFunc( ) is used by DA 412 to deliver primitives from the client to the service.

In step 602 the client module binds itself to the service module using, for example, a DaAddClient( ) function. The arguments to this function include a pointer to the address of a client module callback function PrimFunc( ) that the DA may use to deliver primitives from the service to the client. In this example, when a client wants to use the services of the generic transport layer, it must register its presence by calling the DaAddClient( ) function to create a binding. A successful return from this function call only indicated that DA 412 has initiated the binding, but the binding is not complete until the appropriate primitive (for example “DA_ADDCLIENT_CNF”) is received, indicating that the service has accepted or rejected the binding. In one exemplary embodiment of the XTL service, a client crates a binding to XTL for each transport layer connection that it requires. The binding request may itself contain information to initiate the transport layer connection, or alternatively the client may send subsequent connection request primitives to initiate the connection.

Once primitives can be delivered from the client to the service and vice versa, the DA 412 may deliver a primitive to the client module's PrimFunc( ) callback function in step 604. For example, the primitive “DA_ADDCLIENT_CNF” may be sent by DA 412, to indicate that a path between the client and the service has been successfully established, and is ready for the exchange of primitives. At this point, indicated by step 606, both client and service can exchange primitives through DA 412 using, for example, a DaSendPrim( ) function call. Once the binding steps are completed, the client and the service may begin exchanging primitives. The exchange is symmetrical from the perspective of DA 412, since there is no difference in the way the primitives are delivered from the client to the service and vice versa. However, typically the service will determine the format of the primitives and their sequence of exchange.

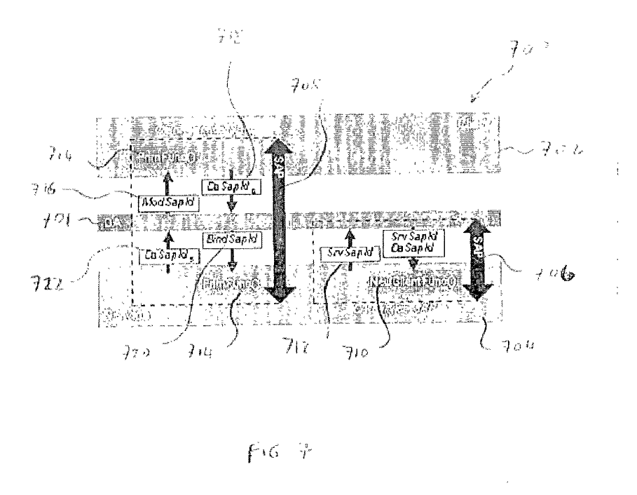

Once the client-service binding has taken place, a service access point (SAP) is defined by the binding. One SAP exists between the XTL core 400 and the application 402 for each transport layer connection. The SAP is a collection of information that is used to identify the binding and to allow modules to easily and rapidly distinguish between different bindings. For example, there may be a SAP defined between the service and the DA for the purpose of new client bindings, and another SAP between the client and the service for the exchange of primitives. FIG. 7 shows one exemplary embodiment of the SAP operation between the DA 701 and the service 704, and between the DA 701 and the client 702. SAP 700 includes a DA-service SAP 706 that may include, for example, a callback service function 710 for new client addition, such as NewClientFunc( ) supplied by the service 704. DA-service SAP 706 may also include a service-assigned parameter 712, such as “SrvSapld”, supplied to the DA 701 in the call DaAddService( ) discussed above. DA 701 supplies the SAPID so that a service can distinguish between multiple services it may offer.

SAP 700 also includes a client-service SAP 708 that may consist, for example, a pair of primitive exchange callback functions 714, such as PrimFunc( ), used by DA 701 to module call backs. A variable 716 “ModSapld” is supplied to DA 701 by the previously described function DaAddClient( ), and is then used by DA 701 to identify the binding in calls to the client's callback function 714. The variable 716 is simply a number to the DA 701, without specific meaning. However, for the module receiving it, variable 716 represents information that the module can use to retrieve information about the binding, such as an index to a table or a pointer to a context block. The pair of SAPID's provides a high performance system for the XTL and for its client to quickly and directly locate context information related to a transport connection, without having to search for the context.

The client-service SAP 708 may also include an exchange of several parameters between DA 701 and client 702 or service 704. For example, a parameter 718 such as “DaSapldc” may be assigned by DA 701 and used to identify the binding in subsequent calls from client 702 to DA 701. A parameter 720 “BinSapld” assigned b service 704 is returned to DA 701 by the service's new client function, and is further supplier by DA 701 to identify the binding in calls to the service's callback PrimFuncL(_). Another parameter 722, such as “DaSaplds” assigned by DA 701 may be supplied by DA 701 in calls to the new client function of the service 704, and may be used to identify the binding in subsequent calls from service 704 to DA 701. In general, according to exemplary embodiments of the invention, clients and services call the DA 701 using a SAPID assigned to the binding by DA 701, while the DA 701 calls clients and services using a SAPID supplied by the client or service.

Although the invention was described with reference to specific exemplary embodiments, the same system can be applied with minimal changes to other protocols. The specification and drawings are thus to be regarded as being illustrative rather than restrictive. It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. An abstraction layer to connect a communications application to a computer network, comprising:
a generic transport layer core, having an abstraction element to generate interfaces to transport layer protocols;
a transport specific interface relating the generic transport layer core to transport layer protocol applications; and
a protocol independent transport interface relating the generic transport layer core to the communications application.

2. The abstraction layer according to claim 1, further comprising a primitive exchange interface of the protocol independent transport interface configured to exchange data elements between the generic transport layer core and the communications application.

3. The abstraction layer according to claim 1, further comprising a service binding interface of the protocol independent transport interface configured to provide binding of the communications application with the generic transport layer core.

4. The abstraction layer according to claim 1, further comprising a delivery agent of the protocol independent transport interface, the delivery agent mediating exchange data between the generic transport layer core and applications registered with the delivery agent.

5. The abstraction layer according to claim 4, wherein the delivery agent is configured to receive a signal indicating availability of a service, to receive a signal indicating a request for service of a client, and to form a path for data exchange between the client and the service.

6. The abstraction layer according to claim 1, further comprising a system services interface to a system library of functions to manage operating system services.

7. The abstraction layer according to claim 1, further comprising a management interface to a system management entity configured to manage configuration and initialization tasks.

8. The abstraction layer'according to claim 1, wherein the generic abstraction layer core is configured to receive protocol independent data from the communications application, to generate transport protocol specific data based at least in part on the protocol independent data, and to send the transport protocol specific data to the transport layer protocol applications.

9. A system of transmitting data over a network, comprising:
a generic transport layer adapted to generate protocol specific data based at least in part on transport independent inputs, and to generate transport independent data based at least in part on protocol specific inputs;
a protocol independent transport interface configured to transmit the transport independent inputs and transport independent data between applications and the generic transport layer; and
a transport specific interface configured to transmit the protocol specific data and protocol specific inputs between the generic transport layer and transport layer protocol applications.

10. The system according to claim 9, further comprising delivery agents configured to mediate exchange of transport independent inputs and data between the applications and the generic transport layer.

11. The system according to claim 9, wherein the transport specific interface is configured to provide the protocol specific data to an internet protocol application.

12. The system according to claim 9, wherein the transport layer protocol applications comprise at least one of a UDP application, TCP application and SCTP application.

13. The system according to claim 9, wherein the applications comprise at least one of MGCP applications, SIP applications and Megaco applications.

14. The system according to claim 10, wherein the delivery agent is further configured to form client-service bindings between the applications and the generic transport layer.

15. The system according to claim 14, further comprising service access points configured to collect information identifying the bindings and provide the information to distinguish between the bindings.

16. The system according to claim 14, wherein the delivery agent is further configured to exchange transport independent inputs from the application to the generic transport layer.

17. A method of transmitting data comprising:
receiving transport independent inputs from applications;
processing the transport independent inputs to generate protocol specific data;
providing the protocol specific data to transport layer protocol applications;
receiving protocol specific inputs from the transport layer protocol applications;
processing the protocol specific inputs to generate transport independent data; and
providing the transport independent data to the applications.
